(19) United States
(12) Patent Application Publication
(10) Pub. No.: US 2003/0194363 A1
(43) Pub. Date: Oct. 16, 2003

(54) Chemical reactor and fuel processor utilizing ceramic technology

(76) Inventors: Chowdary Ramesh Koripella, Scottsdale, AZ (US); Sonja Tasic, Gilbert, AZ (US)

Correspondence Address: MOTOROLA, INC., CORPORATE LAW DEPARTMENT - #56-238, 3102 NORTH 56TH STREET, PHOENIX, AZ, 85018, US

(21) Appl. No.: 10/122,107

(22) Filed: Apr. 12, 2002

(51) Int. Cl. B01J 8/02; F23D 21/00

(52) U.S. Cl. 422/222; 422/211; 422/198; 422/110

(57) ABSTRACT

A multilayered ceramic chemical reactor and method of making the chemical reactor for use in an integrated fuel reformer in the form of a chemical combustion heater or a steam reformer. The ceramic chemical reactor including a three-dimensional multilayer ceramic carrier structure defining a cavity having a cofired catalyst formed therein. An optional cofired porous ceramic support layer can be provided as a layer between the ceramic structure and the catalyst material. The cofired catalyst provides for selective deposition of the catalyst material during fabrication and complete air oxidation of an input fuel during use. The cavity further includes a fuel inlet, an air inlet, and an outlet. The fuel processor includes a monolithic three-dimensional multilayer ceramic carrier structure defining a fuel reformer having heat provided by the integrated chemical reactor.

### FIELD OF INVENTION

The present invention pertains to ceramic technology devices, and more particularly to a chemical reactor and a fuel processor, fabricated utilizing ceramic technology for improved size and performance benefits.

### BACKGROUND OF THE INVENTION

Fuel cell systems for man-portable electrical power supplies, in general, are “battery replacements”. Like batteries, fuel cells produce electricity through an electrochemical process, more specifically, a fuel cell produces electricity from fuel and air without combustion. The electrochemical process utilized provides for the combining of hydrogen, the fuel, with oxygen from the air. The process is accomplished utilizing an electrolyte, such as a polymer electrolyte membrane (PEM), which conducts ions, such as protons. The PEM is sandwiched between two electrodes, namely an anode, the negative electrode used for hydrogen oxidation, and a cathode, the positive electrode used for oxygen reduction. Fuel cells, as known, can perpetually provide electricity as long as fuel and oxygen are supplied. Hydrogen is typically used as the fuel in fuel cells for producing the electricity and it can be processed from methanol, natural gas, petroleum, ammonia, or stored in metal hydrides, carbon nanotubes, or as pure hydrogen. Reformed hydrogen fuel cells (RHFCs) utilize hydrogen fuel processed from liquid or gaseous hydrocarbon fuels, such as methanol, using a reactor, called a fuel reformer, for converting the fuel into hydrogen.

Reformed hydrogen fuel cells preferably utilize methanol that is reformed into hydrogen as a fuel source. Methanol is the preferred fuel for use in fuel reformers for portable applications because it is easier to reform into hydrogen gas at a relatively low temperature compared to other hydrocarbon fuels such as ethanol, gasoline, or butane. The reforming or converting of methanol into hydrogen usually takes place by one of three different types of reforming. These three types are steam reforming, partial oxidation reforming, and autothermal reforming. Of these types, steam reforming is the preferred process for methanol reforming because it is the easiest to control and produces a higher concentration of hydrogen output by the reformer, at a lower temperature, thus lending itself to favored use.

Fuel reformers have been developed for use in conjunction with fuel cell devices, but they are typically cumbersome and complex systems consisting of several discrete sections connected together with gas plumbing and hardware to produce hydrogen gas, and are thus not suitable for portable power source applications. Recently fuel reformers have been developed utilizing ceramic monolithic structures in which the miniaturization of the reformer can be achieved. Utilizing multilayer laminated ceramic technology, ceramic components and systems are now being developed for use in microfluidic chemical processing and energy management systems. Monolithic structures formed of these laminated ceramic components are inert and stable to chemical reactions and capable of tolerating high temperatures. These structures can also provide for miniaturized components, with a high degree of electrical and electronic circuitry or components embedded or integrated into the ceramic structure for system control and functionality. Additionally, the ceramic materials used to form ceramic components or devices, including microchanneled configurations, are considered to be excellent candidates for catalyst supports and so are extraordinarily compatible for use in microreactor devices for generating hydrogen used in conjunction with miniaturized fuel cells.

During steam reforming, raw methanol is catalytically converted, with the application of heat, to a hydrogen enriched fuel gas for use with fuel cells. As previously stated, a common means for converting of methanol into hydrogen takes place by steam reforming. Typically, a steam reformer is endothermically operated at an elevated temperature (180−°-300° C.), thereby ensuring the reforming reaction is maintained in its optimal operating temperature. Common means for generating these elevated temperatures has been found using conventional electrical heaters and chemical reactors for large reformer reactors. Conventional electrical heating has been demonstrated in multilayered ceramic methanol steam reformer reactors for miniaturized applications. At this time there exists a desire to further miniaturize and integrate this means of heating to achieve steam reforming and develop a miniature in-situ chemical reactors which includes catalysts, for portable applications such as elevated temperature fuel cells, microturbines, thermoelectrics, fuel gas production, and the like.

When fabricating a monolithic integrated reformed hydrogen system using multilayer ceramic structures, it has been found that in-situ chemical reactors which typically include a post fire deposition of a catalyst, do not provide for selective deposition of the catalyst material. In many instances, because of the firing of the structure prior to introduction of the catalyst material, the catalyst material is unable to be placed in the areas where it is needed so as to provide optimum temperature profiles as desired by the integrated structures. More specifically, post fire catalyst deposition methods are restricted in deposition because access is limited to the areas where catalytic deposition is sought. This limited access causes the solution to coat everywhere, and not necessarily where it is desired. Accordingly, it is desirable to develop a composition and method of processing a chemical reactor including a cofirable combustion catalyst that can withstand the processing temperatures of the multilayer ceramic structures and yet maintain good catalytic activity.

It is another object of the present invention to provide for a miniaturized chemical reactor including a cofired catalyst immobilized within and a method of fabricating the miniaturized chemical reactor including an immobilized cofired catalyst.

It is yet still another object of the present invention to provide for a miniaturized chemical reactor including a porous ceramic material having a cofired catalyst immobilized within or upon the porous ceramic material and a method of fabricating the miniaturized chemical reactor utilizing ceramic technology.

It is another object of the present invention to provide for a miniaturized chemical reactor including an optional porous ceramic material having a catalyst immobilized within or upon the porous ceramic material and method of fabricating the miniaturized chemical reactor wherein the ceramic structure, the optional porous ceramic material and the catalyst are all cofired during fabrication, thus providing for selective deposition of the catalyst within the multilayer miniaturized chemical reactor.

It is another object of the present invention to provide for a multilayer chemical reactor including a cofired catalyst that is miniaturized for use in conjunction with an integrated fuel cell system for portable device applications.

It is yet another object of the present invention to provide for a monolithic multilayer ceramic fuel processor including an integrated steam reforming chemical reactor including a cofired catalyst of the present invention.

### SUMMARY OF THE INVENTION

The above problems and others are at least partially solved and the above purposes and others are realized in a multilayered ceramic chemical reactor and method of fabricating miniature reactors, including an optional porous ceramic support material which may serve as an intermediate barrier layer when necessary, having a cofired catalyst material immobilized within or upon the optional porous ceramic support layer or formed directly in contact with the ceramic structure. Miniature reactors are designed for use in an integrated fuel processor including a three-dimensional multilayer ceramic carrier structure defining at least one ceramic cavity having a geometric surface area. The optional porous ceramic support layer which is an intermediate porous ceramic support layer is formed within the cavity in a planar or channeled configuration, and is characterized as having a real surface area greater than the geometric surface area of the cavity. The ceramic structure, and if incorporated the porous ceramic support layer, and the catalyst material, are cofired as a single component, thereby providing for selective placement of the catalyst in the areas where needed, and providing for optimum temperature profiles as desired by the integrated structure.

The cavity further includes reactant inlets such as a fuel inlet, an air inlet, and an outlet for reaction products as well as any unreacted input materials. Optionally included is at least one temperature sensor. The temperature sensor is provided to permit feedback control of the feed rate of the input materials. This feedback control of the feed rate of the input materials allows for the maintenance of the reactor at a specific temperature and feed rate. Additionally, disclosed is the integration of miniature reactors into a fuel processing system with components such as a chemical reactor, steam reformer, and a fuel cell.

### BRIEF DESCRIPTION OF THE DRAWINGS

The novel features believed characteristic of the invention are set forth in the claims. The invention itself, however, as well as other features and advantages thereof will be best understood by reference to detailed descriptions which follow, when read in conjunction with the accompanying drawings, wherein:

FIGS. 1-4 are simplified sectional views of a chemical reactor, according to the present invention;

FIG. 5 is a graphical representation illustrating results according to differing catalyst positions according to the present invention;

FIG. 6 is a simplified sectional view of an alternative embodiment of a chemical reactor, according to the present invention;

FIG. 7 is a simplified sectional view of a fuel processor including a chemical reactor, a reactor for reforming methanol to hydrogen and an integrated fuel cell stack according to the present invention; and

FIG. 8 is a schematic diagram of a fuel cell system including integrated chemical reactors for chemical combustion heating and steam reforming as a fuel processing system according to the present invention.

### DESCRIPTION OF THE PREFERRED EMBODIMENTS

The chemical reactors of the present invention are anticipated for use in a fuel processor, or more specifically a chemical reactor and a fuel reformer, that includes vaporization zones and reaction zones with appropriate catalyst for reactions that produce heat in the chemical combustion reactor and hydrogen enriched gas in the fuel reforming reactor. The chemical reactor is thermally coupled to the vaporization and reaction zones of the fuel reformer. The chemical reactors are formed utilizing ceramic technology in which thin ceramic layers are assembled then sintered to provide miniature dimensions in which the encapsulated catalyst converts the inlet fuels into product materials such as water vapor, carbon dioxide, carbon monoxide, nitrogen (from the air) and hydrogen gases, and heat.

Turning now to the drawings, and in particular FIG.1, illustrated in simplified sectional view is a chemical reactor 10 according to the present invention. Chemical reactor 10 is formed using multi-layer ceramic technology, and is defined by a ceramic structure 12. More particularly, chemical reactor 10 is comprised of a plurality of ceramic layers 14 and a catalyst material (discussed presently) that are sintered together during processing to form reactor 10, which in this particular embodiment is formed as a chemical combustion heater. Ceramic structure 12 defines a ceramic cavity 16 therein. Ceramic cavity 16 provides for the control of flow of input materials such as fuel and air (discussed presently). Ceramic cavity 16 is further described as having a geometric surface area as evidenced by a plurality of surfaces 17 that define ceramic cavity 16. A catalyst material 18 is formed in combination with ceramic cavity 16. More particularly, catalyst material 18 in this particular embodiment is described as a platinum (Pt) solution based thick film paste composition that was developed and applied as a stencil print or screen-print to the plurality of surfaces 17 defining ceramic cavity 16. Catalyst 18 is characterized as providing for complete air oxidation of an input fuel 22 and the generation of heat 26 in proportion to the feed rate of input fuel 22 and air 24. Catalyst 18 in the preferred embodiments is formed of a high surface area platinum (Pt). Alternatively, it is anticipated by this disclosure that catalyst 18 can be formed of an active metal such as silver (Ag), palladium (Pd), nickel (Ni), or the like. Various active metal oxides, active metal oxychlorides and active metal oxynitrides can act as alternative catalyst materials to noble metals like Pt as combustion catalysts and as performance enhancing supports for combustion catalyst materials.

In the preferred embodiment, catalyst 18 is deposited as a screen printable or stencil printable thickfilm paste comprising a cofirable Pt catalyst 18, which is compatible with the multilayer ceramic processing. Thickfilm paste for cofirable Pt catalyst 18 typically consists of a organic binder made up of a ethyl cellulose, alpha terpineol solvent, a high surface area gamma alumina catalyst support and a Pt solution mixed thoroughly into a viscous paste suitable for screen printing process. During fabrication, the plurality of ceramic layers 14, and cofirable PT catalyst 18 are sintered, or fired, together to form device 10. During this sintering process, the organic components of the thickfilm Pt catalyst 18 composition will be burned out, leaving a finely dispersed high surface Pt catalyst 18 deposited on the alumina support. In the multilayer ceramic process, individual ceramic layers 14 typically contain a glass component to facilitate sintering at a lower temperature. During the sintering process, this glass can diffuse into the catalyst 18 layer thereby reducing its effectiveness. Typical thickfilm screen print thicknesses range from 2-8 um. In our experiments it has been observed that the glass from the ceramic layers 14 can diffuse into the catalyst film up to ˜6 um, making catalyst 18 ineffective. To obtain an active catalyst after the sintering process, the screen print thickness need to be maintained above ˜6 um, preferably in the range of 10-250 um. At high thicknesses too much Pt catalyst will be used which may not be required for the device functionality but increases the cost of the device. At the low end precautions need to be taken to prevent glass diffusion into the entire catalyst 18 print layer thickness. Typically a barrier layer (discussed presently) consisting of porous alumina below the catalyst print layer will prevent the glass diffusion into the catalyst layer 18, there by allowing for the printing of thinner catalyst layers (2-8um thick).

The platinum loading into the thickfilm catalyst composition is also very important for the effectiveness of the device. Too much Pt loading will increase the cost of the device and is undesirable. Too low Pt loading may not be effective for the complete catalytic combustion, which is the desired function of the device. It has been observed experimentally that a minimum of 1 wt % Pt loading in the paste is required. A preferred range is 1-4 wt % Pt loading. During the multilayer ceramic processing, the catalyst paste is exposed not only to the glass diffused from ceramic layers 14 as explained previously, but also to the sintering temperatures of 700-1000° C., usually 850C. from 10-120 minutes. This high temperature exposure will reduce some of the catalyst activity by reducing the effective surface area of platinum catalyst 18 due to sintering process, requiring a minimum Pt loading into the starting composition.

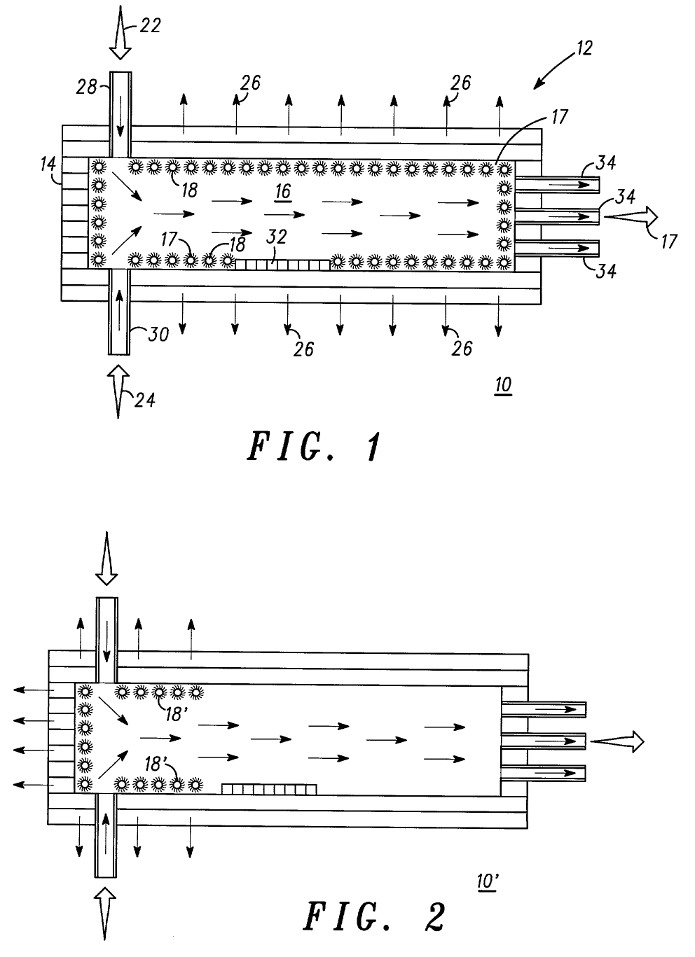

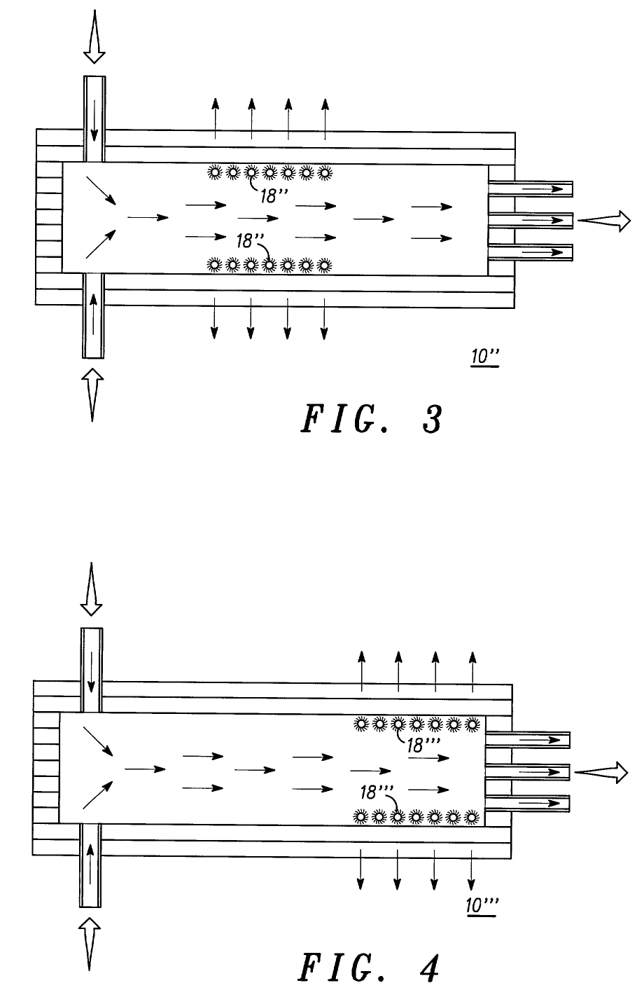

In the embodiment shown in FIG. 1, catalyst 18 is formed on surfaces 17 of cavity 16 prior to the firing of the device, thereby providing for selectivity in the placement of catalyst 18 so as to provide optimum temperature profiles as desired by the integrated structures. Alternatively, FIGS. 2, 3, and 4 show examples of a reactor 10′ including a catalyst 1′, a reactor 10″ including a catalyst 18″, and a reactor 10′″ including a catalyst 18′″, respectively. It should be noted that all components of FIGS. 2-4 that are similar to the components illustrated in FIG. 1, are designated with similar numbers, having a prime, double prime, or triple prime added to indicate the different embodiment. Catalyst 18′, 18″, and 18′″ are formed generally similar to catalyst 18 of FIG. 1, that has been deposited selectively at various locations within reactor 10′, 10″, and 10′″. More specifically, illustrated are a plurality of reactor embodiments including a catalyst selectively deposited at the entrance to the combustion chamber of the reactor as illustrated in FIG. 2, in the middle of the combustion chamber of the reactor as illustrated in FIG. 3, and at the exit end of the combustion chamber of the reactor as illustrated in FIG. 4

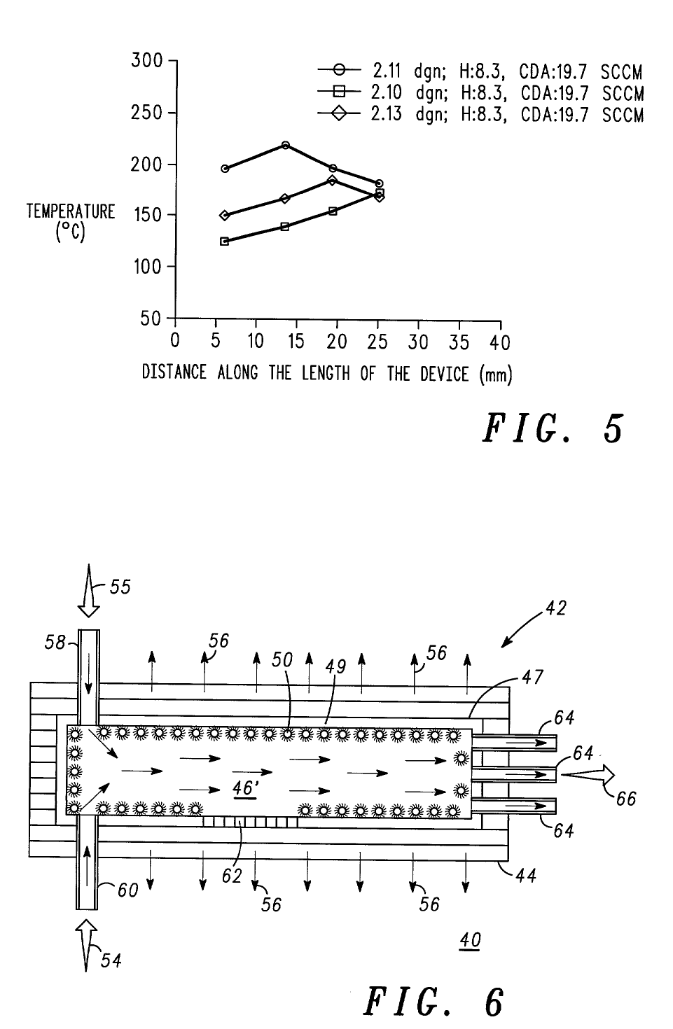

In the embodiments illustrated in FIGS. 2-4, the catalyst was applied as a stencil print of about 22.8 mm diameter and 0.2 mm thick, and placed selectively at various locations in the reactor. Premixed hydrogen fuel and air was supplied to this reactor and the temperature rise of the device due to catalytic combustion was measured on the top and bottom surfaces of the device. FIG. 5 illustrates the temperature profiles along the length of the reactor 10′, 10″ and 10′″ as shown in FIGS. 2, 3, and 4. As seen in FIG. 5, a hot zone generated within each of the reactor 10′, 10″ and 10′″, can be shifted by selective placement of the catalyst material in the combustion chamber. Since the catalyst incorporation was done during the fabrication of the multilayer ceramic device this process allows the design flexibility to selectively place the catalyst as desired to obtain the required temperature profile in the reactor depending on the application in a manufacturable, cost effective method.

Referring back to FIG. 1, during fabrication, the plurality of ceramic layers 14, and catalyst material 18 are sintered, or fired, together to form device 10. More specifically, catalyst 18 is formed on surfaces 17 of cavity 16 prior to the firing of the device, thereby providing for selectivity in the placement of catalyst 18 so as to provide optimum temperature profiles as desired by the integrated structures. In that catalyst 18 is deposited prior to firing of device 10, access is available to all areas for catalytic deposition and solution coats. Catalyst 18 is designed to withstand the processing temperatures of the multilayer ceramic structure 10 and yet maintain good catalytic activity. As previously described, catalyst 18 in a preferred embodiment is formed as a platinum (Pt) solution based thick film paste composition that is applied as a stencil print or screen-print to the surfaces 17 of cavity 16.

During operation, chemical combustion heater 10 is characterized as giving off heat 26 (as noted by directional arrows) in proportion to the feed rate of input fuel 22 in the presence of sufficient or excess air 24. Accordingly, an input fuel inlet 28 is formed to provide for the inlet of input fuel 22 into ceramic cavity 16. Input fuel 22 in a preferred embodiment is hydrogen. Dependent upon use, alternate fuel sources, such as neat methanol, any admixtures of methanol and water, or methanol, water and hydrogen, and even mixtures of these previously mentioned fuels with any other hydrocarbon fuels, like methane, propane, butane, etc., can be used for input fuel 22. In addition, an air inlet 30 provides for the inlet of air 24 (comprised of mainly 20% oxygen and 80% nitrogen) into ceramic cavity 16. This input combination of input fuel 22 and air 24 moves through ceramic cavity 16, and comes in contact with catalyst 18, thereby generating heat 26 as indicated by directional arrows. It should be understood that anticipated by this disclosure is alternatively a single inlet which serves as a combination pre-mixed fuel/air inlet.

Optionally included as a part of device 10 is at least one temperature sensor 32. Temperature sensor 32 is provided to permit feedback control of the feed rate of fuel 22 and air 24 into ceramic cavity 16. Dependent upon desired temperature being reached and modification of that temperature, the feedback control provides for adjustment of the portions and proportion of fuel 22 and air 24 that enters ceramic cavity 16.

During operation of chemical combustion heater 10, catalyst 18 provides for the complete air oxidation of input fuel 22 with air 24. This oxidation provides for the generation of heat 26 which is dissipated through ceramic structure 12. There is provided an outlet 34 which allows for the output of any uncombusted fuel 22 and air 24, and any additional combustion by-product 36 such as carbon dioxide (CO₂), water (H₂O), nitrogen (N₂) or lost heat, generated within ceramic cavity 16. Accordingly, chemical combustion heater 10 is described as generating heat that is dissipated from ceramic cavity 16 through ceramic structure 12.

Referring now to FIG. 6, illustrated is yet another embodiment of a chemical reactor, referenced 40, according to the present invention. Reactor 40 is formed generally similar to the device of FIG. 1. Chemical reactor 40 is formed using multi-layer ceramic technology, and is defined by a ceramic structure 42. More particularly, chemical reactor 40 is comprised of a plurality of ceramic layers 44 that are sintered together during processing (discussed presently) to form reactor 40, which similarly to reactor 10 of FIG. 1 is formed as a chemical combustion heater. Ceramic structure 42 defines a ceramic cavity 46 therein. Ceramic cavity 46 provides for the control of flow of input materials such as fuel and air (discussed presently). Ceramic cavity 46 is further described as having a geometric surface area as evidenced by a plurality of surfaces 47 that define ceramic cavity 46. A porous ceramic support layer 49 is formed within ceramic cavity 46 and is characterized as having a real surface area greater than the geometric surface area of ceramic cavity 16′.

Porous ceramic support layer 49 is disclosed as being formed of a high surface area material, such as a porous ceramic material, thereby characterized as a pure high surface area support. It is anticipated by this disclosure that porous ceramic support layer 49 can additionally act as a barrier layer to prevent catalyst poisoning from the substrate such as from the glass binder or lead formulated in the ceramic tapes which are utilized to fabricate ceramic monoliths.

Porous ceramic support layer 49 is further described as being deposited on surfaces 47 of plurality of ceramic layers 44 and within cavity 46 in a planar (shown) or channeled configuration. Typically, porous ceramic support layer 49 is screen printed from a thick film paste, or deposited via a slurry coating, onto ceramic structure 42 in its green or unfired state during assembly. Next, a catalyst material 48 is formed in combination with porous ceramic support layer 19. Catalyst material 48 in this particular embodiment is described as an impregnated catalyst formed on or within porous ceramic support layer 49. In the example of a chemical combustion heating reactor, catalyst 48 is characterized as providing for complete air oxidation of an input fuel 52 and air 54 and the generation of heat 26′ in proportion to the feed rate of input fuel 53 and air 54. In the example of a steam reforming reactor, catalyst 48 is characterized as providing for the chemical conversion of input material 52 and steam 54 and the absorption of heat 56 in proportion to the feed rate of input material 52 and steam 54.

Porous ceramic support layer 49 is described as being a high surface area support, such as alumina (Al₂O₃), silica (SiO₂), titanium dioxide (TiO₂), zirconium dioxide (ZrO₂), cerium dioxide (CeO₂), lanthanum oxide (La₂O₃) or any combination of these high surface area supports. Catalyst 48 in a preferred embodiment is formed as being cofired with the green ceramic structure in one firing step, and therefore immobilized and providing for complete air oxidation of an input fuel and the generation of heat. Alternatively, catalyst 48 is formed of an active metal such as silver (Ag), palladium (Pd), nickel (Ni), or the like. As previously described with respect to FIG. 1, various active metal oxides, active metal oxychlorides and active metal oxynitrides can act as alternative catalyst materials to noble metals like platinum (Pt) as combustion catalysts and as performance enhancing supports for combustion catalyst materials. In general other metals and combinations of metals with anions, e.g., like ZrOCl₂, AlCOCl, and mixed metal oxychlorides and oxynitrides, etc., can be useful as combustion catalysts and supports for combustion catalysts, and it should additionally be understood that anticipated is a catalyst 48 formed of any combination of active metals, active metal oxides, active metal oxychlorides, and active metal oxynitrides.

Catalyst 48 is disclosed as being formed on a surface 50 of porous ceramic support layer 49. Porous ceramic support layer 49 provides for a more efficient device 40 in that porous ceramic support layer 49 provides for a greater real surface area due to its porosity than the geometric area of cavity 46, and thus provides for maximum utilization of catalyst 48 and maximum optimization of the extent of chemical conversion of chemical reactants such as fuel 52 and oxidant air 54 for chemical combustion for heat generation. Porous ceramic support layer 49 further provides for a more efficient and cost effective device 40 in that porous ceramic support layer 49 provides for enhanced dispersion and therefore utilization of catalyst 48, for enhanced catalytic activity for chemical reactions such as chemical combustion process for heating and methanol steam reforming for enriched gas generation and for enhanced stability of catalyst 48, that is activity of catalyst 48 in time. These enhancements with catalyst 50 on porous ceramic support layer 49 result from catalyst 48 being isolated from any other materials except chemical reactants such as fuel 52, air 54 and porous ceramic support layer 19, and the increased dispersion of the catalysts, that is an increased surface area of the catalyst per unit of mass of catalyst 48 resulting when catalyst 48 is dispersed by depositing catalyst 48 onto porous ceramic support layer 49. Typically this high catalyst 48 surface area results by dispersing a mass, a, of catalyst 48 by depositing a negligible volume of catalyst 18′ material as a thin shell onto the surfaces 52 of porous ceramic support layer 49 with a mass, b, and of a volume, x. Catalyst 48 and porous ceramic support layer 49 composite essentially has a volume, x, which is virtually the same as the geometric volume, x, of the porous ceramic only. This composite volume of catalyst 48 and porous ceramic support layer 49 behaves like a volume, x. A mass, c, of catalyst 48 in the composite volume would be the volume, x, times the density of the catalyst 48. A mass, a, for catalyst 48 filling the whole volume, x, would be much greater than catalyst 18′ mass, c. The enhanced dispersion of catalyst 48 would be proportional to the factor, c/a, which is the equivalent mass of pure catalyst 48 filling the whole volume, x, divided by the mass, a, of the catalyst 48 deposited on the surface of a volume, x, of the porous ceramic support layer 49. The factor c/a is a factor for calculating the beneficial cost savings per gram of catalyst 48 when using a catalyst 48 on a support compared to when using a solid catalyst 48particle.

Lastly, there may be enhancements of the catalytic activity of the highly dispersed catalyst 48 on the porous ceramic support layer 49 for promoting the combustion reaction. These enhancements are due to favorable chemical interactions between catalyst 48 and porous ceramic support layer 49 (so called support effects, which include but are not limited to, favorable alterations of surface properties, like surface acidity, surface tension, etc., resulting from the bonding of porous ceramic support layer 49 with the highly dispersed catalyst 18′, thereby favorably altering catalyst interactions with fuel and/or oxidant).

During fabrication, the plurality of green ceramic layers 44, porous ceramic support layer 49, and catalyst material 48 are sintered (fired) together in one firing process to yield a device including a porous region of high specific surface area suitable for catalytic support that is well adhered to dense ceramic structure 42. More specifically, catalyst 48 is formed on surface 50 of porous ceramic support layer 49, or impregnated within porous ceramic support layer 49, prior to the firing of the device, thereby providing for selectivity in the placement of catalyst 48 so as to provide optimum temperature profiles as desired by the integrated structures. In that catalyst 48 is deposited prior to firing of device 50, access is available to all areas for catalytic deposition and solution coats. Catalyst 48 is designed to withstand the processing temperatures of the multilayer ceramic structure 50 and yet maintain good catalytic activity. As previously stated, catalyst 48 in a preferred embodiment is formed as a platinum (Pt) solution based thick film paste composition that is applied as a stencil print or screen-print to the surfaces 50 of ceramic support layer 49.

Similar to the embodiment described with respect to FIG. 1, during operation, chemical reactor 40 is characterized as giving off heat (as noted by directional arrows 56) in proportion to the feed rate of input fuel 52 in the presence of sufficient or excess air 54. Accordingly, an input fuel inlet 58 is formed to provide for the inlet of input fuel 52 into ceramic cavity 46. Input fuel 52 in a preferred embodiment is hydrogen. Dependent upon use, alternate fuel sources, such as neat methanol, any admixtures of methanol and water, of methanol, water and hydrogen, and even mixtures of these previously mentioned fuels with any other hydrocarbon fuels, like methane, propane, butane, etc., can be used for input fuel 52. In addition, an air inlet 60 provides for the inlet of air 54 (comprised of mainly 20% oxygen and 80% nitrogen) into cavity 46. This input combination of input fuel 52 and air 54 moves through cavity 46, and comes in contact with catalyst 50, thereby generating heat 56 as indicated by directional arrows. It should be understood that anticipated by this disclosure is alternatively a single inlet which serves as a combination pre-mixed fuel/air inlet.

Additionally included as a part of device 40 is at least one temperature sensor 62. It should be understood that the inclusion of temperature sensor 62 is optional and would permit feedback control of the feed rate of fuel 52 and air 54 into ceramic cavity 46. Dependent upon desired temperature being reached and modification of that temperature, the feedback control provides for adjustment of the portions and proportion of fuel 52 and air 54 that enters ceramic cavity 46.

During operation of chemical reactor 40, catalyst 48, formed with porous ceramic support layer 49, provides for the complete air oxidation of input fuel 52 and air 54. This oxidation provides for the generation of heat 56 which is dissipated through ceramic structure 42. There is provided an outlet 34′ which allows for the output of any uncombusted fuel 52 and air 54, and any additional combustion by-product 66 such as carbon dioxide (CO₂), water (H₂O), nitrogen (N₂) or lost heat, generated within ceramic cavity 46. Accordingly, chemical reactor 40 is described as generating heat that is dissipated from ceramic cavity 46 through ceramic structure 42.

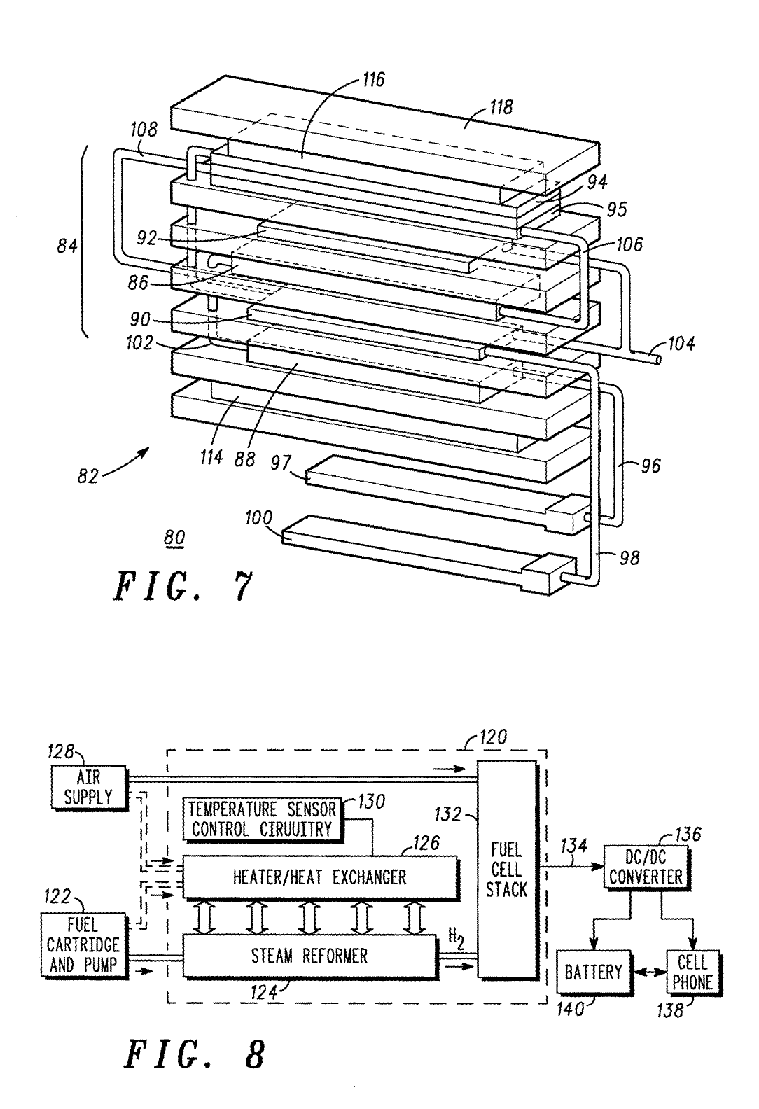

Referring now to FIG. 7, illustrated is a fuel processor system 80 according to the present invention, including a plurality of microfluidic channels and a chemical reactor, which could be fabricated according to either of the previous embodiments disclosed in FIGS. 1-6. Fuel processor system 80 is comprised of a three-dimensional multilayer ceramic structure 82. Ceramic structure 82 is formed utilizing multilayer laminate ceramic technology. Structure 82 is typically formed in component parts which are then sintered in such a way as to provide for a monolithic structure. Ceramic structure 82 has defined therein a fuel processor, generally referenced 84. Fuel processor 84 includes a reaction zone, or fuel reformer, 86, a vaporization chamber, or vaporization zone, 88, and an integrated chemical reactor, 90, generally similar to chemical reactor 10 of FIG. 1 or chemical reactor 40 of FIG. 6. In addition, included as a part of fuel processor 84, is a waste heat recovery zone 92, and a fuel cell stack 94.

Ceramic structure 82 further includes at least one fuel inlet ceramic cavity 96 in fluidic communication with fuel vaporizer 88 and a liquid fuel source comprised of a combination solution of methanol and water 97. At least one fuel input inlet 98 is formed to provide for fluidic communication between a fuel source 100, and combustion heater 90. It should be understood that anticipated by this disclosure is a single fuel tank, that is in fluidic communication with both fuel vaporizer 88 and chemical reactor 90.

During operation of fuel processor 80, fuel 97 enters fuel vaporizer 88 through ceramic cavity 96 and is vaporized with the vaporous methanol and vaporous water (steam) exiting vaporizer 90 thought output 102 which is in fluidic communication with fuel reformer 86. Fuel inlet 98 provides for the input of fuel to chemical reactor 90. An air inlet 104 provides for the input of air to chemical reactor 90 and to waste heat recovery zone 92. Chemical reactor 90 allows for complete air oxidation of fuel input 100 and subsequent dissipation of heat through structure 82 and more specifically, to fuel reformer 86 and fuel vaporizer 88.

As previously stated, fuel 97 entering fuel vaporizer 88 is vaporized and the resultant vaporous methanol and water enters the reaction zone, or more specifically fuel reformer, 86, where it is converted to hydrogen enriched gas. There is provided a hydrogen enriched gas outlet channel 106 from reformer 86 that is in fluidic communication with an inlet to fuel cell stack 94, and more particularly to a fuel cell anode 95. Fuel cell anode 95 provides for depletion of hydrogen from the hydrogen enriched gas mixture. This hydrogen depleted hydrogen enriched gas mixture exits fuel cell 94, and more particularly anode 95 through a fluidic communication 108 and is input to an inlet 110 of chemical reactor 90. Chemical reactor 90 oxidizes portions of this gas mixture to generate heat and provides for any uncombusted materials, such as remaining hydrogen and any carbon monoxide, to undergo air oxidation to water and carbon dioxide, and these as well nitrogen from air, are then vented through outlet 112 away from structure 82 into the atmosphere.

During operation, heat is efficiently transferred from the central aspect of the device, more particularly from chemical reactor 90, to the reformer 86 and fuel vaporizer, or vaporization zone 88 using thermal conductive channels (discussed presently). As previously described, output from fuel vaporizer zone 88 travels via channel 102 to the reaction zone, or to fuel reformer 86, and then through hydrogen enriched gas outlet channel 106 to fuel cell stack 94 to supply hydrogen fuel to stack 94. Spent gases from the fuel cell stack 94 are directed through a waste heat recovery zone 92 to capture the heat from the spent gases.

Efficient thermal insulators 114 and 116 are positioned around fuel processor system 84, under fuel vaporizer zone 88, and above fuel cell 94 to keep outer temperatures low for packaging and also to keep heat generated within the device localized to the fuel processor 84. As illustrated in FIG. 7, in this particular example, high temperature fuel cell stack 94 is integrated with fuel processor 84. This particular fuel cell design allows for the operation of the fuel cell at a temperature ranging from 140-230° C., with a preferred temperature of 150° C. Fuel vaporizer zone 88 operates at a temperature ranging from 120-230° C., with a preferred temperature of 180° C., and the fuel reformer 86 operates at a temperature ranging from 180-300° C., with a preferred temperature of 230° C. Additionally, in this particular embodiment of fuel processor 80, included is a top cap 118.

It should be understood that alternative embodiments encompassing: (i) alternative fuel delivery means, either passive or active pumping; (ii) fuel vaporizer, reaction zone, and chemical heater positions; and (iii) a fuel reformer device without an integrated fuel cell, are anticipated by this disclosure. In particular, anticipated is an embodiment in which only a single fuel supply, namely methanol, or methanol and water, is anticipated. This use of a single methanol, or methanol and water solution would enable the fabrication of a simpler design, without any need for the device to incorporate two fuel tanks. Although it is understood that pure methanol is more efficient and preferred with respect to the chemical reactor, a 1 water and 1 mole methanol solution will also work, but is not deemed literally as operationally efficient. Further, a heater using the water and methanol solution is suitable for practical applications, and would permit a simple common fuel reservoir for feeding the chemical reactor 90 and fuel reformer 86. It should be understood that anticipated by this disclosure is a fuel processor system in which a single methanol solution is utilized with a means of recapturing water from the chemical reactor outlet for mixing with an inlet fuel for fuel reforming.

Next, anticipated are variations on the actual design of system 80, and more particularly to the actual location of the fuel vaporizer zone 88, fuel reformer 86 and chemical reactor 90. In one particular alternative embodiment, it is anticipated that fuel reformer 86 surrounds the chemical reactor 90 on both sides (top and bottom). In yet another alternative embodiment, it is anticipated that fuel reformer 86 can be positioned below chemical reactor 90 and the fuel vaporizer zone 88 on top of chemical reactor 90.

Finally, it is anticipated by this disclosure that although illustrated in FIG. 7 is the integration of fuel cell stack 94 with processor 84, a design in which a fuel cell is not integrated with reformer 86 is anticipated. Further information on a reformed hydrogen fuel system device of this type can be found in U.S. patent application, bearing Ser. No. 09/649,528, entitled “HYDROGEN GENERATOR UTILIZING CERAMIC TECHNOLOGY”, filed Aug. 28, 2000, assigned to the same assignee and incorporated herein by this reference. When fuel cell stack 94 is integrated with fuel reformer 86, advantage can be taken of the heat of the substrate to operate high temperature fuel cell stack 94. For high power applications, it is convenient to design a separate fuel cell stack 94 and a fuel processor unit 84 and couple them to supply the fuel for the fuel cell. In such instances, when a fuel cell stack is not integrated with the fuel processor, and the fuel processor is designed as a stand alone device, external connection can be made to connect the stand alone fuel processor to a traditional fuel cell stack for higher power applications.

Illustrated in FIG. 8 in a simplified flow chart diagram 120, is the fuel processor system 80 of FIG. 7, including a multilayer ceramic structure, a fuel processor, a fuel cell stack, insulators, and fuels, similar to previously described multilayer ceramic structure 82 having a fuel processor 84, fuel cell stack 94, insulators 114 and 116, and fuels 94 and 100 of device 80. As illustrated, a fuel cartridge, generally including an optional pump mechanism, 122 supplies water and methanol into a steam reformer 124, generally similar to fuel reformer 86 of FIG. 7 and a chemical reactor 126, generally similar to heater 10 of FIG. 1, or heater 40 of FIG. 6. An air supply 128 provides for the supplying of air to heater 126 and a fuel cell stack 132. Heater 126 is monitored by a temperature sensor, including control circuitry, 130 thereby providing for steam reformer 124 to operate at a temperature of approximately 230° C. Operation of reformer 124 at this temperature allows for the reforming of input fuel 122 into a reformed gas mixture, generally referred to as the hydrogen enriched gas. More particularly, in the presence of a catalyst, such as copper oxide, zinc oxide, or copper zinc oxide, the fuel solution 122 is reformed into hydrogen, carbon dioxide, and some carbon monoxide. Steam reformer 124 operates in conjunction with an optional carbon monoxide cleanup (not shown), that in the presence of a preferential oxidation catalyst and air (or O₂), reforms a large percentage of the present carbon monoxide into carbon dioxide. This reformed gas mixture supplies fuel through a fuel output to fuel cell 132, generally similar to fuel cell stack 94 of FIG. 7. Fuel cell 132 generates electricity 134 and is illustrated in this particular example as providing energy to a DC-DC converter 136, thereby supplying power to a cell phone 138 and/or battery 140.

Accordingly, described is a chemical reactor including at least one ceramic cavity, defining a geometric surface area, having a cofired catalyst formed therein. An optional porous ceramic support layer, more specifically, a porous ceramic material is formed within the cavity and characterized as having a real surface area greater than the geometric surface area of the cavity. The catalyst material is formed in contact with the cavity surface layers, or in combination with the optional porous ceramic support layer, either positioned on a surface of the porous ceramic support layer, or entrapped within voids formed in the porous ceramic support layer. The catalyst is characterized as being cofired with the green ceramic structure in one firing step, and therefore immobilized and providing for complete air oxidation of an input fuel and the generation of heat. The chemical reactor is formed as either a chemical combustion heater or a steam reformer for integration into a fuel processor. The chemical reactor is formed as a monolithically integrated structure, generally comprised of a plurality of thin ceramic layers that are assembled and having the porous ceramic material formed on a surface of the ceramic layers. During fabrication, as previously described, the ceramic structure, the optional porous ceramic support layer, and the catalyst material are cofired together, thereby providing for a closed zone(s) in which the chemical reactor acts as a chemical combustion heater or a steam reformer.

While we have shown and described specific embodiments of the present invention, further modifications and improvements will occur to those skilled in the art. We desire it to be understood, therefore, that this invention is not limited to the particular forms shown or methods detailed, and we intend in the appended claims to cover all modifications that do not depart from the spirit and scope of this invention.

What is claimed is:

1. A chemical reactor comprising:
a ceramic carrier structure defining at least one ceramic cavity, the at least one ceramic cavity having a geometric surface area; and
a cofired catalyst material formed in combination within the ceramic carrier structure, the catalyst material characterized as providing for complete air oxidation of an input fuel and the generation of heat.

2. A chemical reactor as claimed in claim 1 wherein the chemical reactor is one of a chemical combustion heater or a steam reformer.

3. A chemical reactor as claimed in claim 2 wherein the ceramic structure is a monolithic three-dimensional multilayer ceramic structure.

4. A chemical reactor as claimed in claim 3 wherein the monolithic three-dimensional multilayer ceramic structure is comprised of a plurality of thin ceramic layers that when cofired with the catalyst material provides for a closed heating zone.

5. A chemical reactor as claimed in claim 4 wherein the catalyst material is chosen from the group consisting of: a hydrated metal salt, an active metal, an active metal oxide, an active metal oxychloride, an active metal oxynitride, or a combination of an active metal and an active metal oxide.

6. A chemical reactor as claimed in claim 5 further including a cofired porous ceramic support layer formed within the at least one ceramic cavity, the porous ceramic support layer as having a real surface area greater than the geometric surface area of the ceramic cavity.

7. A chemical reactor as claimed in claim 6 wherein the porous ceramic support layer is formed of a porous ceramic material.

8. A chemical reactor as claimed in claim 7 wherein the porous ceramic material is a high surface area support, formed of one of alumina (Al₂O₃), or zirconia (ZrO₂).

9. A chemical reactor as claimed in claim 7 wherein the catalyst material is formed on a plurality of surfaces of the porous ceramic material prior to firing.

10. A chemical reactor as claimed in claim 7 wherein the catalyst material is entrapped within a plurality of voids formed in the porous ceramic material prior to firing.

11. A chemical reactor as claimed in claim 7 wherein a plurality of ceramic structures are formed within the ceramic cavity structure thereby defining a plurality of channels, the porous ceramic support layer being formed on a surface of the plurality of channels.

12. A chemical reactor as claimed in claim 1 further including at least one temperature sensor for providing feedback control of a feed rate of the input fuel and air.

13. A chemical reactor comprising:
a monolithic three-dimensional multilayer ceramic structure, the monolithic three-dimensional multilayer ceramic structure comprised of a plurality of thin ceramic layers assembled to provide for at least one ceramic cavity having a geometric surface area, and thereby defining a closed heating zone; and
a catalyst material formed in combination with the porous ceramic support layer, the catalyst cofired with the monolithic three-dimensional multilayer ceramic structure and characterized as providing for complete air oxidation of an input fuel and the generation of heat.

14. A chemical reactor as claimed in claim 13 wherein the chemical reactor is formed as one of a chemical combustion heater or a steam reformer reactor.

15. A chemical reactor as claimed in claim 146 further including a plurality of ceramic structures formed therein the ceramic cavity structure and defining a plurality of channels.

16. A chemical reactor as claimed in claim 14 wherein the catalyst material is chosen from the group consisting of: a hydrated metal salt, an active metal, an active metal oxide, an active metal oxychloride, an active metal oxynitride, or a combination of an active metal and an active metal oxide.

17. A chemical reactor as claimed in claim 16 further including a porous ceramic support layer cofired with the monolithic three-dimensional multilayer ceramic structure and the catalyst material, the porous ceramic support layer formed within the at least one ceramic cavity thereby having a real surface area greater than the geometric surface area of the ceramic cavity;

18. A chemical reactor as claimed in claim 17 wherein the porous ceramic support layer is formed on a plurality of ceramic structures formed therein the ceramic cavity structure.

19. A chemical reactor as claimed in claim 17 wherein the porous ceramic material is a high surface support, formed of one of alumina (Al₂O₃), or zirconia (ZrO₂).

20. A chemical reactor as claimed in claim 13 further including at least one temperature sensor for providing feedback control of a feed rate of the input fuel and air.

21. A method of forming a chemical reactor comprising the steps of:
providing a ceramic material;
defining therein the ceramic material, at least one ceramic cavity, the at least one ceramic cavity having a geometric surface area;
depositing therein the at least one ceramic cavity a catalyst material;
cofiring the ceramic material and the catalyst material to form a ceramic carrier structure having the at least one ceramic cavity defined therein and having an immobilized catalyst characterized as providing for complete air oxidation of an input fuel and the generation of heat.

22. A method of forming a chemical reactor as claimed in claim 21 wherein the step of cofiring the ceramic material and the catalyst material to form a ceramic carrier structure includes cofiring a plurality of thin ceramic layers and the catalyst material to provide for a closed heating zone.

23. A method of forming a chemical reactor as claimed in claim 22 further including the step of depositing a porous ceramic support layer on a plurality of surfaces of the at least one ceramic cavity, the catalyst material deposited in contact with the porous ceramic support layer prior to firing the ceramic material and the catalyst material to form the ceramic carrier structure.

24. A method of forming a chemical reactor as claimed in claim 23 wherein the step of depositing a porous ceramic support layer includes the step of depositing a porous ceramic material formed of one of alumina (Al₂O₃), or zirconia (ZrO₂)

25. A method of forming a chemical reactor as claimed in claim 23 wherein the step of depositing a catalyst material in contact with the porous ceramic support layer includes the step of depositing a catalyst material chosen from the group consisting of: a hydrated metal salt, an active metal, an active metal oxide, an active metal oxychloride, an active metal

26. A method of forming a chemical reactor as claimed in claim 23 wherein the step of depositing a catalyst material in contact with the porous ceramic support layer includes the step of entrapping the catalyst within at least one of a plurality of voids formed in the porous ceramic support layer and on a surface of the porous ceramic support layer.

27. A fuel processor comprising:
a thermally conductive ceramic carrier defining a fuel reformer, the fuel reformer including a reaction zone including a reforming catalyst and an integrated chemical reactor thermally coupled to the reaction zone, wherein the chemical reactor has defined therein a ceramic cavity, and a cofired catalyst material, to air oxidize an input fuel to produce heat;
an inlet channel for liquid fuel;
an outlet channel for hydrogen enriched gas; and
an integrated fuel cell, including an anode in microfluidic communication with the outlet channel.

28. A fuel processor and integrated fuel cell as claimed in claim 27 wherein the fuel reformer further includes a fuel vaporization zone.

29. A fuel processor as claimed in claim 28 wherein the chemical reactor further includes an air inlet for providing oxygen for the oxidation of the fuel and a fuel input inlet to provide fuel to the chemical reactor.

30. A fuel processor as claimed in claim 29 wherein the integrated chemical reactor provides heat to the fuel vaporization zone and reaction zone using the thermally conductive ceramic carrier.

31. A fuel processor as claimed in claim 30 wherein the integrated chemical reactor including a catalyst arranged to oxidize an input fuel to produce heat includes a catalyst material chosen from the group consisting of: a hydrated metal salt, an active metal, an active metal oxide, an active metal oxychloride, an active metal
